(19) United States
(12) Patent Application Publication
(10) Pub. No.: US 2014/0268217 A1
(43) Pub. Date: Sep. 18, 2014

(54) OPERATION HISTORY IMAGE STORAGE APPARATUS, IMAGE PROCESSING APPARATUS, METHOD FOR CONTROLLING STORING OF OPERATION HISTORY IMAGE, AND NON-TRANSITORY COMPUTER READABLE MEDIUM

(71) Applicant: FUJI XEROX CO., LTD., Tokyo (JP)

(72) Inventors: Yuichi KAWATA, Kanagawa (JP); Tomitsugu KOSEKI, Kanagawa (JP); Hideki YAMASAKI, Kanagawa (JP); Kensuke OKAMOTO, Kanagawa (JP); Nobuaki SUZUKI, Kanagawa (JP); Yoshifumi BANDO, Kanagawa (JP)

(73) Assignee: FUJI XEROX CO., LTD., Tokyo (JP)

(21) Appl. No.: 13/963,142

(22) Filed: Aug. 9, 2013

(30) Foreign Application Priority Data
Mar. 18, 2013 (JP) 2013-055309

(51) Int. Cl. H04N 1/00; G06K 9/00

(52) U.S. Cl. CPC H04N 1/00832; H04N 1/00347; G06K 9/00369
USPC 358/1.15

(57) ABSTRACT

An operation history image storage apparatus includes an imaging unit that captures an image of a specific area facing a processing apparatus which performs processing in accordance with an operation by an operator, a controller that controls the imaging unit to capture an image of an operation state with respect to the processing apparatus, an extracting unit that extracts a person image from the image of the specific area captured by the imaging unit, a masking unit that masks whole or a part of a background image other than the person image extracted by the extracting unit, and a storing unit that stores the image of the specific area after masking by the masking unit as operation history information of the operator operating the processing apparatus.

### CROSS-REFERENCE TO RELATED APPLICATIONS

This application is based on and claims priority under 35 USC 119 from Japanese Patent Application No. 2013-055309 filed Mar. 18, 2013.

### BACKGROUND

1. Technical Field

The present invention relates to an operation history image storage apparatus, an image processing apparatus, a method for controlling storing of an operation history image, and a non-transitory computer readable medium.

2. Summary

According to an aspect of the invention, there is provided an operation history image storage apparatus including an imaging unit that captures an image of a specific area facing a processing apparatus which performs processing in accordance with an operation by an operator, a controller that controls the imaging unit to capture an image of an operation state with respect to the processing apparatus, an extracting unit that extracts a person image from the image of the specific area captured by the imaging unit, a masking unit that masks whole or a part of a background image other than the person image extracted by the extracting unit, and a storing unit that stores the image of the specific area after masking by the masking unit as operation history information of the operator operating the processing apparatus.

### BRIEF DESCRIPTION OF THE DRAWINGS

Exemplary embodiments of the present invention will be described in detail based on the following figures, wherein:

FIG. 1 is a schematic diagram of an image processing apparatus according to a first exemplary embodiment;

FIG. 2 is a block diagram showing the configuration of a power supply system and a control system of the information processing apparatus according to the first exemplary embodiment;

FIG. 3A is a perspective view showing the image processing apparatus and its surroundings, with an operator not facing the image processing apparatus according to the first exemplary embodiment;

FIG. 3B is a perspective view showing the image processing apparatus and its surroundings, with an operator facing the image processing apparatus according to the first exemplary embodiment;

FIG. 4 is a block diagram illustrating the functions of a camera controller of a main controller according to the first exemplary embodiment;

FIG. 5 is a plan view illustrating an imaging area of an imaging device according to the first exemplary embodiment;

FIG. 6 is a side view illustrating the imaging area of the imaging device according to the first exemplary embodiment;

FIG. 7A is a front view of a raw image captured by the imaging device;

FIG. 7B is a front view illustrating areas obtained by dividing the angle of view of the raw image;

FIG. 7C is a front view of a stored image that is obtained by performing mask processing on the raw image;

FIG. 8 is a flowchart illustrating the procedure of imaging control performed by the camera controller of the main controller according to the first exemplary embodiment;

FIG. 9 is a block diagram illustrating the functions of a camera controller of a main controller according to a second exemplary embodiment;

FIG. 10A is a front view of a raw image according to the second exemplary embodiment;

FIG. 10B is a front view of a stored image that is obtained by performing mask processing on the raw image according to the second exemplary embodiment;

FIG. 11 is a block diagram illustrating the functions of a camera controller of a main controller according to a third exemplary embodiment;

FIG. 12A is a front view of a raw image according to the third exemplary embodiment; and

FIG. 12B is a front view of a stored image that is obtained by performing mask processing on the raw image according to the third exemplary embodiment.

### DETAILED DESCRIPTION

### First Exemplary Embodiment

FIG. 1 is a schematic diagram of an image processing apparatus 10 according to a first exemplary embodiment.

The image processing apparatus 10 is provided with processing devices (which may also be collectively referred to as “devices”) including an image forming unit 12 that forms an image on recording paper, an image reading unit 14 that reads a document image, and a facsimile communication control circuit 16. A recording paper discharge tray 10T is formed between the image forming unit 12 and the other devices (the image reading unit 14 and the facsimile communication control circuit 16). Recording paper with an image recorded thereon by the image forming unit 12 is discharged onto the recording paper discharge tray 10T.

Further, an operation unit 46 is provided on a housing of the image reading unit 14. The operation unit 46 includes a UI touch panel 40 shown in FIG. 2, and other hard keys (not shown)

Further, a human-detecting sensor 30 is attached to a vertical rectangular pillar 50 forming part of the housing of the image processing apparatus 10 and supporting the image reading unit 14.

The image processing apparatus 10 includes a main controller 18, and controls the image forming unit 12, the image reading unit 14, and the facsimile communication control circuit 16 so as to, for example, temporarily store image data of a document image read by the image reading unit 14, and transmit the read image data of the document image to the image forming unit 12 or the facsimile communication control circuit 16.

A communication network 20, such as the Internet, is connected to the main controller 18, while a telephone network 22 is connected to the facsimile communication control circuit 16. The main controller 18 is connected to a personal computer (PC) 29 (see FIG. 2) via the communication network 20 so as to receive image data. Further, the main controller 18 serves to perform facsimile transmission and reception using the telephone network 22 through the facsimile communication control circuit 16.

The image reading unit 14 includes a document table for positioning a document, a scanning drive system that scans the image of the document placed on the document table while radiating light, and a photoelectric conversion element, such as Charge Coupled Device, that receives light reflected or transmitted by scanning by the scanning drive system and converts the light into an electric signal.

The image forming unit 12 includes a photoconductor. A charging device that uniformly charges the photoconductor, a scanning exposure unit that scans a light beam on the basis of the image data, an image developing unit that develops an electrostatic latent image formed by scanning exposure by the scanning exposure unit, a transfer unit that transfer the developed image on the photoconductor onto recording paper, and a cleaning unit that cleans the surface of the photoconductor after transfer are provided around the photoconductor. Further, a fixing unit that fixes the image transferred on the recording paper is provided on a transport path of recording paper.

A plug 26 is attached at the end of an input power cable 24 of the image processing apparatus 10. When the plug 26 is inserted into a wiring plate 32 of a commercial power source 31 connected to a wall W, the image processing apparatus 10 receives power from the commercial power source 31. The image processing apparatus 10 of the first exemplary embodiment is configured such that commercial power is supplied by an ON/OFF operation of a master power switch 41.

The master power switch 41 is provided as part of internal components that are exposed when a panel 10P is opened toward the front side of the image processing apparatus 10 (by being rotated about its lower edge).

Further, in the first exemplary embodiment, a sub power operation unit 44 is provided in addition to the master power switch 41. The sub power operation unit 44 serves to select an operation mode of each of the devices to which power is supplied when the master power switch 41 is ON.

The image processing apparatus 10 of the first exemplary embodiment is provided with an imaging device 52 that captures an image of an operator 60 who faces the image processing apparatus 10 and enters operation instructions.

The imaging device 52 is supported by a bracket 54 attached to the rear side of the image processing apparatus 10, and is disposed above the uppermost end of the image reading unit 14. The imaging optical axis of the imaging device 52 extends diagonally downward toward the front of the image processing apparatus 10.

Accordingly, the imaging area of the imaging device 52 always includes the space where the operator 60 in front of and facing the image processing apparatus 10 is operating the operation unit 46 (see FIG. 3B).

Note that the imaging optical axis does not have to extend diagonally downward toward the front of the image processing apparatus 10, and the direction of the optical axis may be changed in accordance with the place where the image processing apparatus 10 is installed. Further, an adjusting mechanism may be provided that is capable of adjusting the vertical and horizontal positions and the direction of the imaging optical axis of the imaging device.

The imaging timing of the imaging device 52 and image processing control for captured images are described below.

(Hardware Configuration of Control System of Image Processing Apparatus)

FIG. 2 is a schematic diagram showing the hardware configuration of a control system of the image processing apparatus 10.

The communication network 20 is connected to the main controller 18 of the image processing apparatus 10. Note that the PC (terminal apparatus) 29 that can serve as the transmission source of image data and the like is connected to the communication network 20.

The facsimile communication control circuit 16, the image reading unit 14, the image forming unit 12, the UI touch panel 40, and an IC card reader/writer 58 are connected to the main controller 18 via respective buses 33A through 33E, such as data buses and control buses. That is, the processing units of the image processing apparatus 10 are mostly controlled by the main controller 18. Note that a UI touch panel backlight 40BL is attached to the UI touch panel 40.

Further, the image processing apparatus 10 includes a power unit 42, which is connected to the main controller 18 with a signal harness 43.

The power unit 42 receives power supplied from the commercial power source 31 through the input power cable 24. The master power switch 41 is attached to the input power cable 24.

The power unit 42 are provided with power lines 35A through 35E that independently supply power to the main controller 18, the facsimile communication control circuit 16, the image reading unit 14, the image forming unit 12, the UI touch panel 40, and the IC card reader/writer 58, respectively. Thus, the main controller 18 may perform partial power-saving control by individually supplying power (power supply mode) or not supplying power (sleep mode) to the devices (hereinafter also referred to as “processing devices” and “modules”) during the operation mode of the devices.

Further, the human-detecting sensor 30 is connected to the main controller 18, and is configured to monitor the presence or absence of a person around the image processing apparatus 10, more specifically, the presence or absence of the operator 60 who is operating the operation unit 46 including the UI touch panel 40 of the image processing apparatus 10.

The human-detecting sensor 30 according to the first exemplary embodiment is configured to detect the presence or absence (the existence or non-existence) of a moving body. The human-detecting sensor 30 may typically be a reflection-type sensor or the like (reflection-type sensor) that includes a light emitting unit and a light receiving unit. The light emitting unit and the light receiving unit may be provided separately from each other.

The most distinctive feature of the reflection-type sensor or the like serving as the human-detecting sensor 30 is reliably detecting the presence or absence of a moving body on the basis of whether the light toward the light receiving unit is interrupted. Further, because the amount of light incident on the light receiving unit is limited by the amount of light emitted from the light emitting unit, the detection area is an area at relatively close range. The term “moving body” as used herein refers to an object that can move on its own. A typical example of the moving body is the operator 60. In other words, the human-detecting sensor 30 detects not only objects in motion, but also detects moving objects at rest.

Further, the human-detecting sensor 30 is not limited to a reflection-type sensor. However, the detection area of the human-detecting sensor 30 may include an area where the UI touch panel 40 and the hard keys of the image processing apparatus 10 are operated. As a guide, the detection critical distance (the most distant position) is set in a range of 0.2 to 1.0 m. The imaging area of the above-described imaging device 52 is included in this area.

(Operation Log Storing by Imaging Device 52)

The image processing apparatus 10 according to the first exemplary embodiment captures an image of the operator 60 facing the image processing apparatus 10 by using the imaging device 52, stores the image (which may be a moving image or a still image) of a specific area, and analyzes what type of operation the operator is in trouble with and whether there is masquerading in the authentication process (such as face recognition and ID authentication) on the basis of the captured image (hereinafter also referred to as “operation analysis”) for future improvement in the operability of the image processing apparatus 10.

Note that, as shown in FIG. 3B, the specific area corresponds to an angle of view 56 (see the dotted lines in FIG. 3B) including the upper body of the operator 60 facing the image processing apparatus 10.

The imaging device 52 operates under the control of the main controller 18, and starts image capture when a moving body (the target is the operator 60) facing the image processing apparatus 10 is detected by the human-detecting sensor 30, and ends image capture when the moving body is no longer detected by the human-detecting sensor 30. The imaging start timing and the imaging end timing may be delayed by a timer or the like.

Information on the image of the specific area captured by the imaging device 52 is stored in a hard disk (HDD) 62 connected to the main controller 18. The stored information on the image of the specific area is stored in association with imaging data and time information in the chronological order, and is read when needed such that analysis is performed.

When the imaging device 52 captures an image of the specific area with the angle of view 56 indicated by the dotted line of FIG. 3B, as shown in FIG. 7A, an image of objects other than the operator 60 (for example, in the case where there is a wall at the rear side, a confidential information medium (paper medium) 64 on the wall) may be included as background of the image of the angle of view 56. The confidential information on this confidential information medium is not used for the operation analysis.

Thus, in the first exemplary embodiment, distance information of the image captured as the imaging area is obtained, and the image of the operator is distinguished from a background image 66 other than the operator 60. Then, mask processing is performed on this background image 66 other than the operator 60. Note that the image area of the confidential information medium 64 is included in the background image other than the operator 60.

FIG. 4 is a block diagram illustrating operations in the main controller 18 for performing image processing on image information captured by the imaging device 52 and storing the processed image information in the hard disk 62. Note that this block diagram illustrates operations in the main controller 18 classified by function, and does not illustrate the hardware configuration.

As shown in FIG. 2, the main controller 18 includes a camera controller 18CMR that controls operation of the imaging device 52.

The imaging device 52 includes a visible light camera 68, an infrared camera 70, and an imaging controller 72.

The imaging controller 72 is connected to an imaging timing controller 74 of the camera controller 18CMR. The human-detecting sensor 30 is connected to the imaging timing controller 74. When the human-detecting sensor 30 detects a moving body, the imaging timing controller 74 outputs an imaging instruction signal to the imaging controller 72. Thus, the imaging controller 72 controls the visible light camera 68 and the infrared camera 70 so as to synchronously control their imaging timings.

The visible light camera 68 performs normal image capture with the angle of view 56 indicated by the dotted line of FIG. 3B, and inputs captured image information (information obtained by converting optical signals into electrical signals) to an image input unit 76 provided in the camera controller 18CMR. The image input unit 76 performs division into angles of view for classification based on the distance from the imaging device 52 to the object, performs necessary image processing, and transmits the image information to the mask processing unit 78.

Note that the necessary image processing may include usual image processing such as adjusting the contrast, density, intensity, and brightness. Further, the visible light camera 68 may capture an image of an area greater than a predetermined image area and perform image processing so as to crop the image to the angle of view 56.

On the other hand, the infrared camera 70 captures an image with the angle of view 56 using infrared light, in synchronization with the visible light camera 68, and inputs the image to a distance determining unit 77.

The distance determining unit 77 assigns information on the distance to the object to each of the divided angles of view (see FIG. 7B) into which the imaging area is divided, on the basis of information on the image captured by the infrared camera 70.

In the first exemplary embodiment, the image that is needed is an image of the operator 60. The position of the operator 60 is a position from which the operation unit 46 of the image processing apparatus 10 can be operated. Accordingly, it is possible predict a distance 1 from the imaging device 52 (see FIGS. 5 and 6).

Further, as shown in FIGS. 5 and 6, a distance 2 is the distance to the position of the wall which is imaged as a background image, and a threshold is set between the predicted distance 1 and the distance 2.

The distance determining unit 77 compares the threshold with distance information of the image of each of the angles of view obtained by dividing the captured image area (angle of view 56), and classifies the image as a person image (an image corresponding to a distance less than the threshold) or a background image other than a person (an image corresponding to a distance greater than the threshold), and transmits the result to the mask processing unit 78. Note that an image corresponding to a distance equal to the threshold may be classified as either a person image or a background image.

The mask processing unit 78 replaces the area of the angle of view (background image other than a person) corresponding to a distance determined to be greater than the threshold with a solid black image. After that, a storing controller 80 stores the result in the hard disk 62. This replacement with a black solid image is mask processing (see FIG. 7C).

In the first exemplary embodiment, the mask processing on the imaging area using the above procedure does not involves a step of temporarily storing a background image in the hard disk 62 during the process such that images stored in the hard disk 62 do not include a background image other than a person.

Note that, in the first exemplary embodiment, a signal line connected to the hard disk 62 may be connected to the image input unit 76 via an encoding unit 82 so as to encode so-called raw image (raw data) and store the encoded image in the hard disk 62, aside from the mask processing step.

The operation of the first exemplary embodiment will be described with reference to the flowchart of FIG. 8.

FIG. 8 is a flowchart illustrating an imaging control routine performed by the camera controller 18CMR of the main controller 18 using the imaging device 52.

In step S100, a determination is made on whether a moving body is detected by the human-detecting sensor 30. This determination is a determination on whether an operator is present in front of the image processing apparatus 10. If the determination in step S100 is negative, this routine ends.

On the other hand, if the determination in step S100 is affirmative, an operator is determined to be present in front of the image processing apparatus 10. Then, the process proceeds to step S102, in which the imaging device 52 is instructed to start image capture. Then, the process proceeds to step S104.

In step S104, the visible light camera 68 and the infrared camera 70 synchronously start image capture. Then, the process proceeds to step S106, in which a raw image captured by the visible light camera 68 is temporarily stored in a volatile memory. This storage area serves as a work area for performing image processing using the raw image.

In the next step S108, the image captured by the visible light camera 68 (see FIG. 7A) is divided into angles of view for comparison of the imaging distance (see FIG. 7B). Then, the process proceeds to step S110, in which distance information based on photographic information obtained by the infrared camera 70 is assigned to each of the divided angles of view. Then, the process proceeds to step S112.

In step S112, each angle of view is compared with the threshold, and is classified into a distance 1 group or a distance 2 group (see FIGS. 5 and 6). The distance 1 group is a group of angles of view determined to be person images, and the distance 2 group is a group of angles of view determined to be background images.

In the next step S114, mask processing is performed on the distance 2 group, that is, images determined to be background images. Then in step S116, after the mask processing, all the pieces of image information of the image area captured by the visible light camera 68 are stored in a non-volatile memory (HDD 62). Then, the process proceeds to step S118 (see FIG. 7C).

In step S118, a determination on whether a moving body is detected by the human-detecting sensor 30, that is, whether an operator is present is made. If the determination is affirmative, the process returns to step S104 to repeat the above steps. The term “repeat” as used herein may be used regardless of whether the imaging device 52 captures a moving image or captures still images at predetermined time intervals (that is, frame-by-frame images). Note that still images and moving images do not have to be distinguished from each other, and an extension of still images (frame-by-frame images captured at a minimal interval) may be defined as a moving image.

On the other hand, if the determination in step S118 is negative, the process proceeds to step S120. In step S120, the imaging device 52 is instructed to end the image capture, so that this routine ends.

### Second Exemplary Embodiment

Hereinafter, a second exemplary embodiment will be described with reference to FIGS. 9, 10A, and 10B. Note that components identical to those in the first exemplary embodiment are denoted by the same reference numerals and are not further described herein.

A characteristic feature of the second exemplary embodiment is detecting the contour of a person image from image information captured by an infrared camera 70.

FIG. 9 is a block diagram illustrating operations in a main controller 18 for performing image processing on image information captured by an imaging device 52 and storing the processed image information in a hard disk 62 according to the second exemplary embodiment. Note that this block diagram illustrates operations in the main controller 18 classified by function, and does not illustrate the hardware configuration.

An imaging controller 72 is connected to an imaging timing controller 74 of a camera controller 18CMR. A human-detecting sensor 30 is connected to the imaging timing controller 74. When the human-detecting sensor 30 detects a moving body, the imaging timing controller 74 outputs an imaging instruction signal to the imaging controller 72. Thus, the imaging controller 72 controls a visible light camera 68 and the infrared camera 70 so as to synchronously control their imaging timings.

The visible light camera 68 performs normal image capture with the angle of view 56 indicated by the dotted line of FIG. 3B, and inputs captured image information (information obtained by converting optical signals into electrical signals) to an image input unit 76 provided in the camera controller 18CMR. The image input unit 76 performs necessary image processing, and transmits the image information to a mask processing unit 78.

Note that the necessary image processing may include usual image processing such as adjusting the contrast, density, intensity, and brightness. Further, the visible light camera 68 may capture an image of an area greater than a predetermined image area and perform image processing so as to crop the image to the angle of view 56.

On the other hand, the infrared camera 70 captures an image with the angle of view 56 using infrared light, in synchronization with the visible light camera 68, and inputs the image to a contour determining unit 90.

The contour determining unit 90 detects boundary information between a person image and a background image on the basis of information (distance information) on the image captured by the infrared camera 70. The boundary information may be coordinate information or vector information.

The mask processing unit 78 replaces the area of the background image other than a person (see a raw image of FIG. 10A) recognized on the basis of the boundary information with a solid black image (see FIG. 10B). After that, a storing controller 80 stores the result in the hard disk 62. This replacement with a black solid image is mask processing.

In the second exemplary embodiment, the mask processing on the imaging area using the above procedure does not involve a step of temporarily storing a background image in the hard disk 62 during the process such that images stored in the hard disk 62 do not include a background image other than a person.

Note that, in the second exemplary embodiment, a signal line connected to the hard disk 62 may be connected to the image input unit 76 via an encoding unit 82 so as to encode so-called raw image (raw data) and store the encoded image in the hard disk 62, aside from the mask processing step.

### Third Exemplary Embodiment

Hereinafter, a third exemplary embodiment will be described with reference to FIGS. 11, 12A, and 12B. Note that components identical to those in the first and second exemplary embodiments are denoted by the same reference numerals and are not further described herein.

A characteristic feature of the third exemplary embodiment is that the infrared camera 70 used in the first and second exemplary embodiments is not needed, and character information is detected from image information captured by a visible light camera 68 such that mask processing is performed on the area of the character image.

FIG. 11 is a block diagram illustrating operations in a main controller 18 for performing image processing on image information captured by an imaging device 52 and storing the processed image information in a hard disk 62 according to the third exemplary embodiment. Note that this block diagram illustrates operations in the main controller 18 classified by function, and does not illustrate the hardware configuration.

An imaging controller 72 is connected to an imaging timing controller 74 of a camera controller 18CMR. A human-detecting sensor 30 is connected to the imaging timing controller 74. When the human-detecting sensor 30 detects a moving body, the imaging timing controller 74 outputs an imaging instruction signal to the imaging controller 72. Thus, the imaging controller 72 controls the imaging timing of the visible light camera 68.

The visible light camera 68 performs normal image capture with the angle of view 56 indicated by the dotted line of FIG. 3B, and inputs captured image information (information obtained by converting optical signals into electrical signals) to an image input unit 76 provided in the camera controller 18CMR. The image input unit 76 performs necessary image processing, and transmits the image information to a mask processing unit 78.

Note that the necessary image processing may include usual image processing such as adjusting the contrast, density, intensity, and brightness. Further, the visible light camera 68 may capture an image of an area greater than a predetermined image area and perform image processing so as to crop the image to the angle of view 56.

The image input unit 76 also transmits the captured image information to a character recognizing unit 92, in addition to the mask processing unit 78. The character recognizing unit 92 extracts character information from the captured image information. Generally, it is often the case that character information is concentrated on a paper medium 64 in a captured image (a wall 66W). Therefore, when character information is extracted, the region of the extracted character information may be collectively recognized as a certain section (rectangular region) (character region 93).

The character recognizing unit 92 transmits position information in the angle of view 56 (see FIG. 3B) indicating the sectioned character region to the mask processing unit 78. Note that although a certain section such as a bulletin board is the character region 93 in the third exemplary embodiment, each character may be recognized as a character region.

The mask processing unit 78 replaces the character region (see a raw image of FIG. 12A) recognized on the basis of the position information indicating the character region with a solid black image (see FIG. 12B). After that, a storing controller 80 stores the result in the hard disk 62. This replacement with a black solid image is mask processing.

In the third exemplary embodiment, the mask processing on the imaging area using the above procedure does not involve a step of temporarily storing a background image in the hard disk 62 during the process such that images stored in the hard disk 62 do not include a character image.

Note that, in the third exemplary embodiment, a signal line connected to the hard disk 62 may be connected to the image input unit 76 via an encoding unit 82 so as to encode so-called raw image (raw data) and store the encoded image in the hard disk 62, aside from the mask processing step.

Further, in some cases, an image visualized as a result of encoding is a series of random characters, for example. Accordingly, in the case where encoding is performed, the encoded image (for example, a series of random characters) may be used without generation of a so-called “black solid image” performed as mask processing on the above-described first through third exemplary embodiments.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An operation history image storage apparatus comprising:
an imaging unit that captures an image of a specific area facing a processing apparatus which performs processing in accordance with an operation by an operator;
a controller that controls the imaging unit to capture an image of an operation state with respect to the processing apparatus;
an extracting unit that extracts a person image from the image of the specific area captured by the imaging unit;
a masking unit that masks whole or a part of a background image other than the person image extracted by the extracting unit; and
a storing unit that stores the image of the specific area after masking by the masking unit as operation history information of the operator operating the processing apparatus.

2. The operation history image storage apparatus according to claim 1, further comprising:
a moving body detector that detects whether a moving body enters a monitoring area including at least the specific area, in the processing apparatus;
wherein the controller causes the imaging unit to continue image capture while the moving body is detected by the moving body detector.

3. The operation history image storage apparatus according to claim 1,
wherein the extracting unit includes
a distance information obtaining unit that obtains distance information corresponding to the image of the specific area,
a comparing unit that compares a distance obtained by the distance information obtaining unit with a predetermined threshold, and
a determining unit that determines an image corresponding to a distance less than the threshold as the person image on the basis of a result of the comparison by the comparing unit; and
wherein the masking unit masks whole of the background image other than the person image determined by determining unit.

4. The operation history image storage apparatus according to claim 3, wherein the distance information obtaining unit obtains the distance information on the basis of photographic information obtained by an infrared camera.

5. The operation history image storage apparatus according to claim 1,
wherein the extracting unit includes
a recognizing unit that analyzes the image of the specific area captured by the imaging unit and recognizes a masking requiring image that requires masking, and
a determining unit that determines the masking requiring image recognized by the recognizing unit as a part of the background image other than the person image; and
wherein the masking unit masks the masking requiring image which is determined by the determining unit as a part of the background image other than the person image.

6. The operation history image storage apparatus according to claim 5, wherein the recognizing unit includes a character recognizing unit that recognizes a character image, and recognizes the character image recognized by the character recognizing unit as the masking requiring image.

7. The operation history image storage apparatus according to claim 1, further comprising:
a preventing unit that prevents the storing unit from performing a storing operation until the masking unit masks whole or a part of the background image other than the person image in the image of the specific area;
wherein the storing unit is a non-volatile memory.

8. The operation history image storage apparatus according to claim 1, further comprising:
a face recognizing unit that recognizes a face image from the person image;
wherein the masking unit masks the face image recognized by the face recognizing unit, in addition to the background image other than the person image.

9. The operation history image storage apparatus according to claim 1, wherein an original image of the image masked by the masking unit is encoded and stored, and a masked state is releasable by decoding by a predetermined operator.

10. The operation history image storage apparatus according to claim 1, wherein the image masked by the masking unit is an image obtained by encoding an original image, and a masked state is releasable by decoding by a predetermined operator.

11. An image processing apparatus comprising:
the operation history image storage apparatus of claim 1;
wherein the processing apparatus includes at least either one of an image reading apparatus that reads image information or an image forming apparatus that forms an image on recording paper on the basis of image information.

12. A method for controlling storing of an operation history image, the method comprising:
capturing an image of an operation state in which an operator operates a processing apparatus in a specific area facing the processing apparatus;
extracting a person image from the captured image of the specific area;
masking whole or a part of a background image other than the extracted person image; and
storing the image of the specific area after masking as operation history information of the operator operating the processing apparatus.

13. A non-transitory computer readable medium storing a program causing a computer to execute a process for controlling storing of an operation history image, the process comprising:
capturing an image of an operation state in which an operator operates a processing apparatus in a specific area facing the processing apparatus;
extracting a person image from the captured image of the specific area;
masking whole or a part of a background image other than the extracted person image; and
storing the image of the specific area after masking as operation history information of the operator operating the processing apparatus.
